(19) United States
(12) Patent Application Publication
(10) Pub. No.: US 2023/0219435 A1
(43) Pub. Date: Jul. 13, 2023

(54) CHARGING GUN

(71) Applicant: WALSIN LIHWA CORPORATION, Taipei (TW)

(72) Inventors: Shih-Hsiang WANG, Taipei (TW); Jia-Xing LIN, Taipei (TW); Shih-Wei WANG, Taipei (TW); Min-Hsiu TSAI, Taipei (TW)

(21) Appl. No.: 18/147,067

(22) Filed: Dec. 28, 2022

Related U.S. Application Data
(60) Provisional application No. 63/297,239, filed on Jan. 7, 2022.

(30) Foreign Application Priority Data
Dec. 1, 2022 (TW) 111146251

(51) Int. Cl. B60L 53/16; H01R 13/717; H01R 13/66

(52) U.S. Cl. CPC B60L 53/16; H01R 13/7175; H01R 13/6683; H01R 2201/26

(57) ABSTRACT

A charging gun is applicable to a charger station. The charging gun includes a charging gun body and a charge state display apparatus. The charge state display apparatus includes a charge state sensor, a display light module, and a controller. The charge state sensor is configured to sense a charge state of the charger station. The display light module is arranged on the charging gun body. The display light module includes a first light-emitting element, a second light-emitting element, and a third light-emitting element. The controller is electrically connected to the charge state sensor and the display light module. The controller is configured to control the first light-emitting element, the second light-emitting element, or the third light-emitting element to emit light according to the charge state.

### CROSS-REFERENCES TO RELATED APPLICATIONS

This application claims the benefit of U.S. provisional application Ser. No. 63/297,239, filed on Jan. 7, 2022 and claims the priority of Patent Application No. 111146251 filed in Taiwan, R.O.C. on Dec. 1, 2022. The entirety of the above-mentioned patent applications are hereby incorporated by references herein and made a part of the specification.

### BACKGROUND

### Technical Field

The present disclosure relates to a charging gun, and in particular, to a charging gun capable of displaying a charge state.

### Related Art

With the increasingly more extensive use of electric vehicles, a charger (also referred to as a charging pile) also becomes increasingly more popular as supporting equipment, so as to meet the demand of a user for charging an electric vehicle. The electric vehicle is charged by plugging a charging connector (also referred to as a charging gun) of the charger into a charging outlet on the electric vehicle.

Since a storage battery of the electric vehicle is the main power source, improper charging has adverse effects on the battery. Therefore, it is very important to get the charge state at any time during the charging.

In addition, since the charging pile and the charging gun may be arranged outdoors and withstand the sun and rain, considering the durability and use safety, the waterproof performance of the above charging device also needs special attention in the structural design.

### SUMMARY

In view of the shortcomings of the prior art, the present disclosure provides a charging gun applicable to a charger station. The charging gun includes a charging gun body and a charge state display apparatus. The charge state display apparatus includes a charge state sensor, a display light module, and a controller.

The charge state sensor is configured to sense a charge state of the charger station. The display light module is arranged on the charging gun body. The display light module includes a first light-emitting element, a second light-emitting element, and a third light-emitting element. The controller is electrically connected to the charge state sensor and the display light module. The controller is configured to control the first light-emitting element, the second light-emitting element, or the third light-emitting element to emit light according to the charge state.

According to the present disclosure, different light-emitting modes of the display light module are used to indicate various charge states, so that the user can have an understanding of a current charge state through the light emitted by the display light module while operating the charging gun. In addition, since the display light module is arranged on the charging gun body, the user can conveniently and directly observe the light-emitting mode of the display light module.

### BRIEF DESCRIPTION OF THE DRAWINGS

FIG. 1 is a schematic diagram of a charger station and a charging gun according to some embodiments of the present disclosure.

FIG. 2 is a function block diagram of a charge state sensor, a display light module, and a controller according to some embodiments of the present disclosure.

FIG. 3 is a schematic diagram showing that a display light module in the form of a display light strip is arranged on a charging gun body, according to some embodiments of the present disclosure.

FIG. 4 is a schematic diagram of an internal structure of a charging gun body according to some embodiments of the present disclosure.

FIG. 5 is a schematic diagram showing connection between a terminal of a charging gun body and a cable and a terminal temperature sensor, according to some embodiments of the present disclosure.

FIG. 6A is a schematic diagram showing arrangements of light-emitting element groups, according to some embodiments of the present disclosure.

FIG. 6B is a schematic diagram of a staggered arrangement of light-emitting elements, according to some embodiments of the present disclosure.

FIG. 6C is a schematic diagram of same light-emitting elements side by side according to some embodiments of the present disclosure.

FIG. 6D is a schematic diagram showing that light-emitting elements are arranged in a manner of m*n, according to some embodiments of the present disclosure.

FIG. 7 is a schematic diagram showing that a voltage varies with time when a charging gun is plugged into a charging outlet on an electric vehicle, according to some embodiments of the present disclosure.

FIG. 8 is a flowchart showing a determination of a controller, according to some embodiments of the present disclosure.

FIG. 9 is a flowchart showing a determination of a controller, according to some embodiments of the present disclosure.

FIG. 10 is a schematic diagram showing that a display light module in the form of a display light block is arranged on a charging gun body, according to some embodiments of the present disclosure.

FIG. 11 is a schematic cross-sectional view taken along line A-A in FIG. 10 according to some embodiments of the present disclosure.

FIG. 12 is a schematic diagram showing connection between a display light module and a fixed assembly, according to some embodiments of the present disclosure.

### DETAILED DESCRIPTION

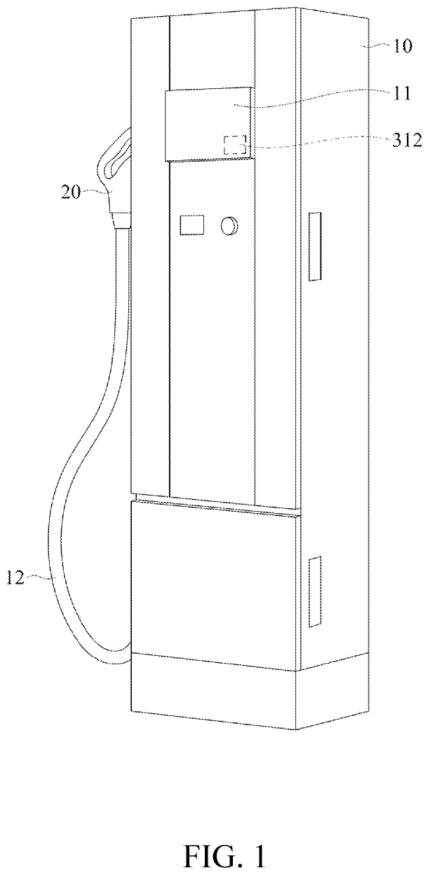

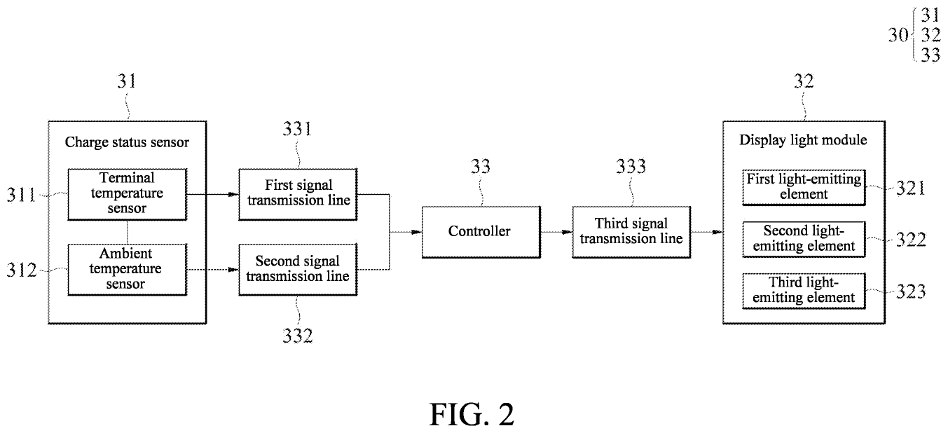

Refer to FIG. 1 and FIG. 2. The present disclosure provides a charging gun applicable to a charger station 10. The charger station 10 is electrically connected to the charging gun by a cable 12. The charging gun includes a charging gun body 20 and a charge state display apparatus 30. The charge state display apparatus 30 includes a charge state sensor 31, a display light module 32, and a controller 33. The charger station 10 is configured to convert mains supply to charge an electric vehicle. The charging gun is connected to a charging outlet of the electric vehicle for transmitting electrical energy outputted by the charger station 10 to a storage battery of the electric vehicle.

Refer to FIG. 1 and FIG. 2. The charge state sensor 31 is configured to sense a charge state of the charger station 10. In some embodiments, the charge state includes whether the charger station 10 is in a non-charging state and a charging state, an ambient temperature, and the like. The display light module 32 is arranged on the charging gun body 20. The display light module 32 includes a first light-emitting element 321, a second light-emitting element 322, and a third light-emitting element 323. The controller 33 is electrically connected to the charge state sensor 31 and the display light module 32. The controller 33 is configured to control a light-emitting mode of the first light-emitting element 321, the second light-emitting element 322, or the third light-emitting element 323 according to the charge state.

Therefore, according to light-emitting modes with different colors and different illumination modes in the present disclosure, a user can easily know a current charge state of the charger station 10. Furthermore, in dimly-lit places or at night, the user may also quickly know the position of the charging gun in this way.

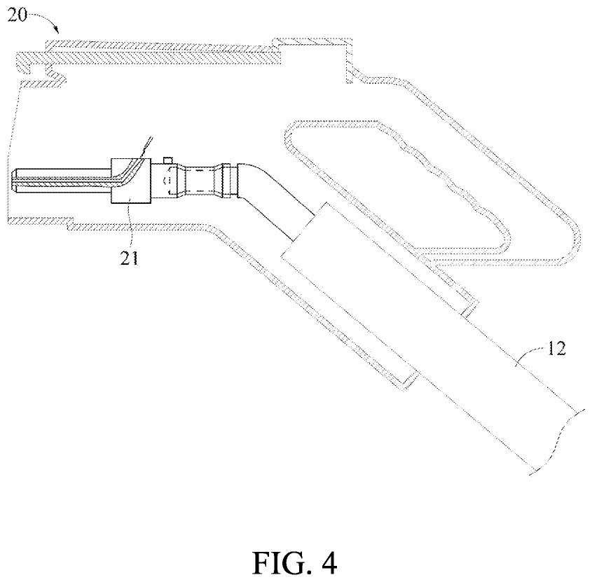

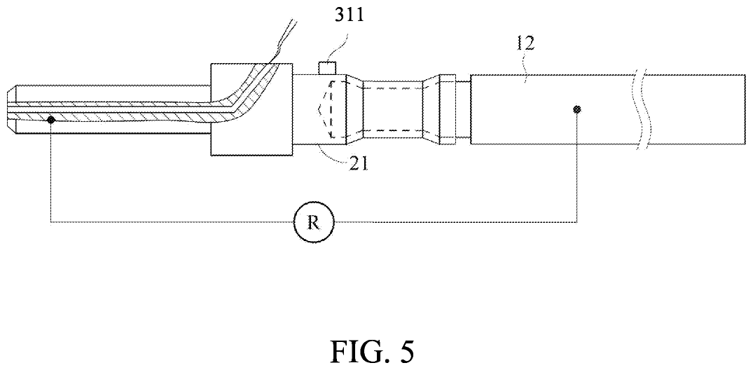

Refer to FIG. 1, FIG. 2, FIG. 4, and FIG. 5. In some embodiments, the charge state sensor 31 includes a terminal temperature sensor 311 and an ambient temperature sensor 312. The terminal temperature sensor 311 is electrically connected to the controller 33 by a first signal transmission line 331, and the ambient temperature sensor 312 is electrically connected to the controller 33 by a second signal transmission line 332. The controller 33 is a charger controller, and the controller 33 is electrically connected to the display light module 32. The terminal temperature sensor 311 measures a temperature of the terminal 21 of the charging gun body 20, and information about the measured terminal temperature is transmitted to the controller 33 through the first signal transmission line 331. The ambient temperature sensor 312 measures an ambient temperature of the charging gun body 20, and information about the measured ambient temperature is transmitted to the controller 33 through the second signal transmission line 332. The controller 33 performs analysis and determination according to the information about the terminal temperature and the information about the ambient temperature to generate a control signal. The controller 33 transmits the control signal to the display light module 32 to control the display light module 32 to display the charge state of the charging gun in the corresponding light-emitting mode and illumination mode.

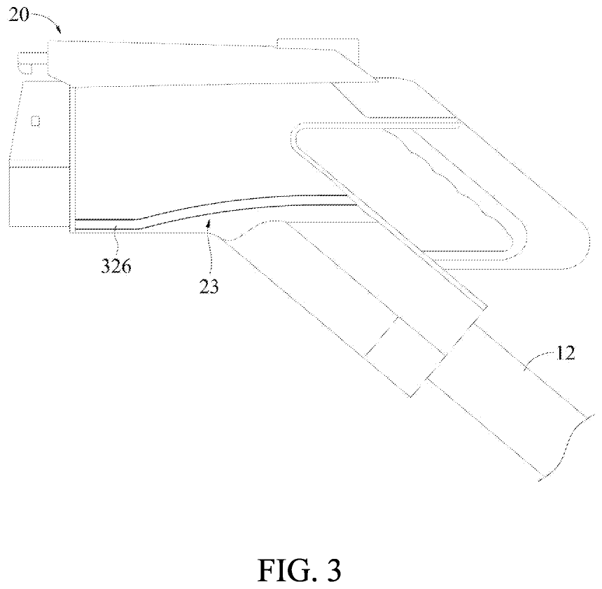

Refer to FIG. 3, FIG. 4, and FIG. 5. In some embodiments, the terminal temperature sensor 311 is arranged on the terminal 21 in the charging gun body 20 to monitor and measure the actual temperature of the terminal 21. In some embodiments, at least two terminal temperature sensors 311 are further arranged, that is, a first terminal temperature sensor and a second terminal temperature sensor (not shown). The first terminal temperature sensor and the second terminal temperature sensor are respectively arranged on a positive terminal and a negative terminal (not shown) in the charging gun body 20 to respectively sense actual temperatures of the positive terminal and the negative terminal.

Refer to FIG. 1 and FIG. 2. In some embodiments, the ambient temperature sensor 312 is arranged on a panel 11 of the charger station 10 and configured to sense the ambient temperature. However, the present disclosure is not limited thereto. The ambient temperature sensor 312 may be arranged at any position of the charger station 10 as long as the ambient temperature can be sensed.

In an embodiment, the terminal temperature sensor 311 or the ambient temperature sensor 312 is a thermistor with a negative temperature coefficient, a thermistor with a positive temperature coefficient, a thermocouple, a resistive temperature sensor, or other elements capable of temperature sensing.

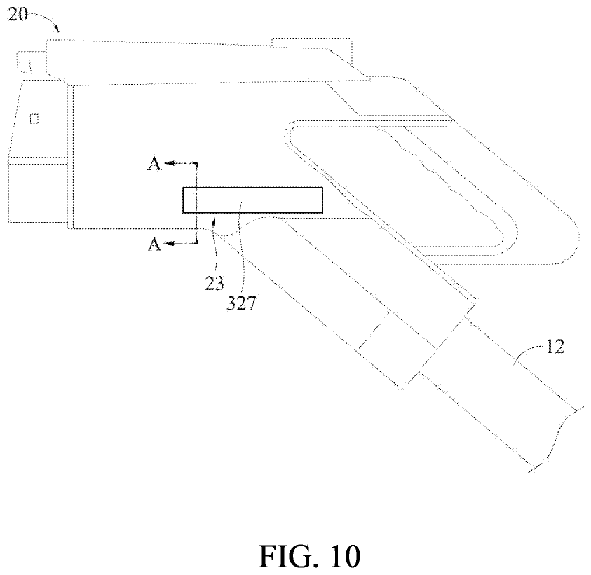

Refer to FIG. 2 and FIG. 3. In some embodiments, the display light module 32 includes a plurality of light-emitting elements. Three light-emitting elements are used as an example, which are respectively a first light-emitting element 321, a second light-emitting element 322, and a third light-emitting element 323. Each light-emitting element has a different color, but the present disclosure is not limited thereto. A number of light-emitting elements may be adjusted according to the actual application. In some embodiments, the first light-emitting element 321 is a blue light-emitting diode, the second light-emitting element 322 is a green light-emitting diode, and the third light-emitting element 323 is a red light-emitting diode, which are respectively configured to emit three preset colors such as blue light, green light, and red light. The first light-emitting element 321, the second light-emitting element 322, and the third light-emitting element 323 are not limited to the light-emitting diodes that emit blue light, green light, and red light, but may also be replaced with light-emitting diodes of different colors according to actual requirements, and only three light-emitting diodes are required for identifying different colors. In some embodiments, the display light module 32 not only may be directly arranged on the charging gun body 20 in the form of a light number for direct presentation, but also may be arranged on the charging gun body 20 in the form of a display light strip 326 or a display light block 327 in FIG. 10.

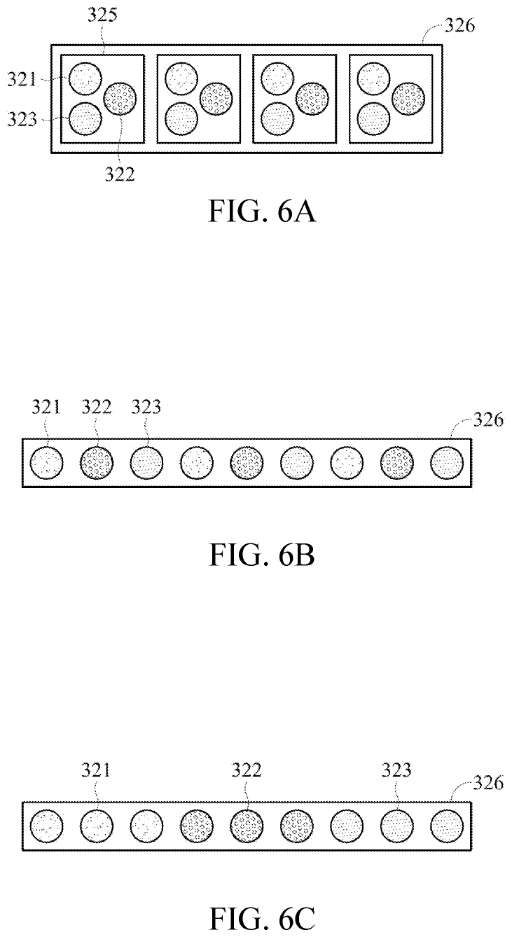

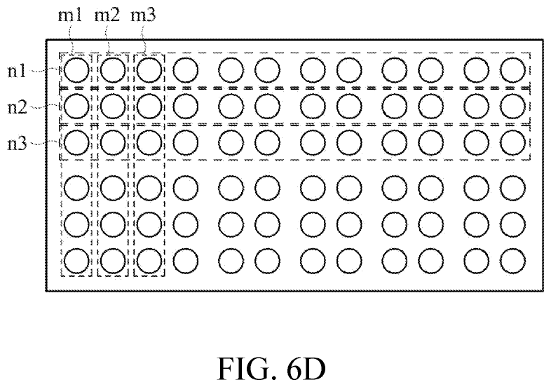

In some embodiments, the display light strip 326 may include a plurality of multi-color light-emitting diodes. As shown in FIG. 6A, the first light-emitting element 321, the second light-emitting element 322, and the third light-emitting element 323 form a light-emitting element group 325. In this way, a wide range of colors may be selected, and a color gradient effect may be realized. In addition, the display light strip 326 may also include a plurality of monochromatic light-emitting diodes. As shown in FIG. 6B, the first light-emitting element 321, the second light-emitting element 322, and the third light-emitting element 323 are staggered with respect to each other. Alternatively, as shown in FIG. 6C, a plurality of first light-emitting elements 321 are arranged side by side, a plurality of second light-emitting elements 322 are arranged side by side, and a plurality of third light-emitting elements 323 are arranged side by side, which are respectively configured to emit blue light, green light, and red light. In order to improve the light-emitting effect, the light-emitting diodes may also be matched with appropriate scattering mechanisms or diffusers.

In some embodiments, in the display light module 32, different colors of light emitted by the light-emitting diodes indicate different sensed temperatures, and different illumination modes (always illuminated and flickering) indicate a non-charging state and a charging state. In detail, when the controller 33 performs analysis and determination according to the information about the terminal temperature and the information about the ambient temperature, the light color and illumination mode are as follows:

Blue light: indicating that ambient temperature>terminal temperature−ΔT;

Green light: indicating that ambient temperature≤terminal temperature−ΔT (appropriate temperature);

Red light: indicating that terminal temperature>critical temperature (excessively high temperature);

Always illuminated: indicating not charging or stopping charging, which indicates that the charger station 10 is on standby;

Flickering: indicating charging in progress.

ΔT is a temperature difference. In one embodiment, ΔT=5° C. and the critical temperature=85° C. ΔT=5° C. and the critical temperature=85° C. are used as an example below to describe the technical content of the present disclosure in detail.

When the controller 33 determines that the ambient temperature is greater than the terminal temperature minus 5° C. and the charger station 10 is in a non-charging state, the controller 33 generates a first control signal to the first light-emitting element 321 (a blue light-emitting diode), so that the first light-emitting element emits always illuminated blue light, which indicates that the charger is on standby. When the controller 33 determines that the ambient temperature is greater than the terminal temperature minus 5° C. and the charger station 10 is in a start-of-charging state, the controller 33 also generates the first control signal to the first light-emitting element 321, so that the first light-emitting element emits flickering blue light, which indicates that the charger station 10 is in an initial start-of-charging state.

When the controller 33 determines that the ambient temperature is less than or equal to the terminal temperature minus 5° C. and the charger station 10 is in a stop-of-charging state, the controller 33 generates a second control signal to the second light-emitting element 322 (a green light-emitting diode), so that the second light-emitting element emits always illuminated green light. When the controller 33 determines that the ambient temperature is less than or equal to the terminal temperature minus 5° C. and the charger station 10 is in a charging state, the controller 33 also generates the second control signal to the second light-emitting element 322, so that the second light-emitting element emits flickering green light, which indicates that the charger station 10 is in a charging state.

When the controller 33 determines that the terminal temperature of any terminal temperature sensor is greater than 85° C. and the charger station 10 is in the charging state, the controller 33 generates a third control signal to the third light-emitting element 323 (a red light-emitting diode), so that the third light-emitting element emits flickering red light. In this case, it indicates that the temperature of the terminal 21 of the charging gun body 20 is excessively high, and the controller 33 performs charging with reduced load, that is, by reducing a charging current/voltage until the terminal temperature is less than 85° C.

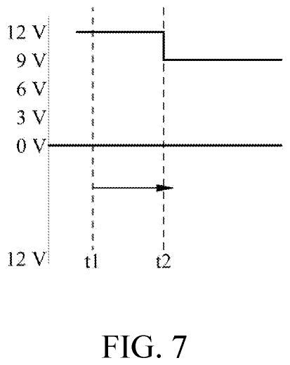

Referring to FIG. 7, when the charging gun is not connected to the electric vehicle, a voltage of a signal terminal maintains 12 V. When the charging gun is plugged into the charging outlet of the electric vehicle, the signal terminal of the charging gun detects the voltage change. The voltage drops from 12 V in a first time t1 to 9 V in a second time t2, which indicates that the charging gun is already connected to the electric vehicle, and then the charger station 10 performs handshaking with the electric vehicle to confirm the start of charging.

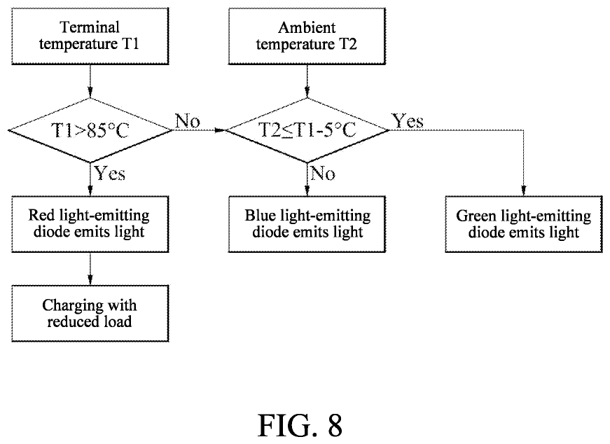

Referring to FIG. 8, in an embodiment, when the controller 33 receives the terminal temperature T1 from the terminal temperature sensor 311 and determines that any terminal temperature T1 is greater than 85° C., the controller 33 generates a third control signal to the third light-emitting element 323 (a red light-emitting diode), so that the third light-emitting element emits red light. In this case, it indicates that the temperature of the terminal 21 is excessively high, and the controller 33 performs charging with reduced load. When the controller 33 determines that any terminal temperature is not greater than 85° C., the controller 33 further determines a relationship between the ambient temperature T2 and the terminal temperature T1.

When the controller 33 determines that the ambient temperature T2 is greater than the terminal temperature T1 minus 5° C., the controller 33 generates the first control signal to the first light-emitting element 321 (a blue light-emitting diode), so that the first light-emitting element emits blue light. When the controller 33 determines that the ambient temperature T2 is less than or equal to the terminal temperature minus 5° C., the controller 33 generates the second control signal to the second light-emitting element 322 (a green light-emitting diode), so that the second light-emitting element emits green light. Therefore, in the present disclosure, the temperature change of the charging state of the charger station 10 may easily know through different colors emitted by the display light module 32.

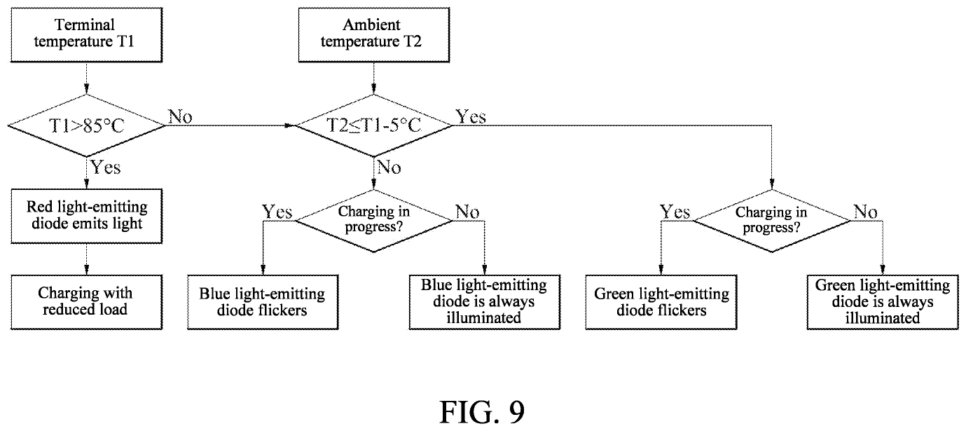

Referring to FIG. 9, in an embodiment, after the controller 33 receives the terminal temperature T1 from the terminal temperature sensor 311 and determines that any terminal temperature T1 is greater than 85° C., the controller 33 generates a third control signal to the third light-emitting element 323 (a red light-emitting diode), so that the third light-emitting element 323 starts flickering. In this case, it indicates that the temperature of the terminal 21 is excessively high, and the controller 33 performs charging with reduced load. When the controller 33 determines that any terminal temperature is not greater than 85° C., the controller 33 further determines a relationship between the ambient temperature T2 and the terminal temperature T1.

When the controller 33 determines that the ambient temperature T2 is greater than the terminal temperature T1 minus 5° C., the controller further determines whether the charger station 10 is in the charging state. When the controller 33 determines that the charger station 10 is in the charging state, the controller 33 generates the first control signal to the first light-emitting element 321 (a blue light-emitting diode), so that the first light-emitting element 321 starts flickering to emit flickering blue light, which indicates that the charger station 10 is in an initial start-of-charging state. When the controller 33 determines that the charger station 10 is not in the charging state, the controller 33 also generates the first control signal to the first light-emitting element 321, so that the first light-emitting element 321 is always illuminated to emit always illuminated blue light, which indicates that the charger station 10 is on standby.

When the controller 33 determines that the ambient temperature T2 is less than or equal to the terminal temperature T1 minus 5° C., the controller 33 further determines whether the charger station 10 is in a charging state. When the controller 33 determines that the charger station 10 is in the charging state, the controller 33 generates the second control signal to the second light-emitting element 322 (a green light-emitting diode), so that the second light-emitting element 322 starts flickering to emit flickering green light, which indicates that the charger station 10 is in the charging state. When the controller 33 determines that the charger station 10 is not in the charging state, the controller 33 also generates the second control signal to the second light-emitting element 322, so that the second light-emitting element 322 is always illuminated to emit always illuminated green light, which indicates that the charger station 10 stops charging.

In this embodiment, a temperature relationship between the ambient temperature T2 and the terminal temperature T1 is determined first, and then it is determined whether the charger station 10 is in the charging state. In another embodiment, the controller 33 may first determine whether the charger station 10 is in the charging state, and then determine the temperature relationship between the ambient temperature T2 and the terminal temperature T1.

In some embodiments, in the display light module 32, different colors of light emitted by the light-emitting elements indicate that the charger station 10 is in different states. When the charger station 10 is in a standby state, the controller 33 generates a fourth control signal to the first light-emitting element 321 (a blue light-emitting diode), so that the first light-emitting element 321 emits blue light. When the charger station 10 is in the charging state, the controller 33 generates a fifth control signal to the second light-emitting element 322 (a green light-emitting diode), so that the second light-emitting element 322 emits green light. When the charger station 10 is in the charging completed state, the controller 33 generates a sixth control signal to the third light-emitting element 323 (a red light-emitting diode), so that the third light-emitting element 323 emits red light. In short, as shown below, the user can know the charge state of the charger station 10 according to the light color.

Blue light: indicating that the charger station 10 is on standby;

Green light: indicating that the charger station 10 is in the charging state;

Red light: indicating that charging is completed (the charging gun has not been pulled out).

The first light-emitting element 321, the second light-emitting element 322, and the third light-emitting element 323 are not limited to the light-emitting diodes that emit blue light, green light, and red light, but may also be replaced with light-emitting diodes of different colors according to actual requirements, and only three light-emitting diodes are required for identifying different colors. In addition, the above states and the corresponding color light of the states are only examples. The expression may also be changed to green light indicating that the charger station 10 is on standby or red light indicating that the charger station 10 is on standby.

Referring to FIG. 10 and FIG. 6D, the display light module 32 is a display light block 327 arranged on the gun belly 23 of the charging gun body 20, so that the user can easily observe the operation of the display light module 32 when holding the charging gun. The display light block 327 means a matrix arrangement of a plurality of light-emitting elements in m*n. An arrangement mode of the light-emitting elements may be that the first light-emitting element 321, the second light-emitting element 322, and the third light-emitting element 323 are randomly arranged. Alternatively, a first row m1 is a plurality of first light-emitting elements 321 arranged at intervals, a second column m2 is a plurality of second light-emitting elements 322 arranged at intervals, a third column m3 is a plurality of third light-emitting elements 323 arranged at intervals, and so on. Alternatively, a first column n1 is a plurality of first light-emitting elements 321 arranged at intervals, a second column n2 is a plurality of second light-emitting elements 322 arranged at intervals, a third column n3 is a plurality of third light-emitting elements 323 arranged at intervals, and so on.

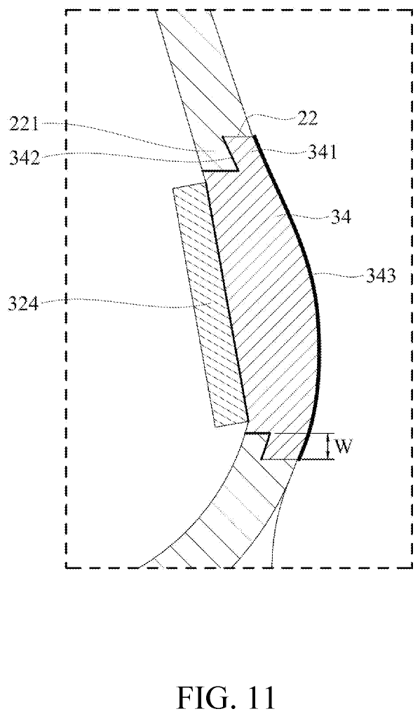

Referring to FIG. 11, in some embodiments, the charging gun body 20 is provided with a groove 22. A transparent cover 34 is arranged in the groove 22, and the display light module 32 is arranged on an inner side of the transparent cover 34. The transparent cover 34 may be arranged in the groove 22 by applying adhesive therebetween, or the transparent cover 34 may be embedded in the groove 22. As shown in FIG. 11, in some embodiments, a first shoulder 221 is arranged along an open edge of the groove 22, and a second shoulder 341 is arranged along an edge of the transparent cover 34. When the transparent cover 34 is embedded in the groove 22, the second shoulder 341 laps the first shoulder 221, and an adhesive layer 342 is arranged between the second shoulder 341 and the first shoulder 221 to achieve an airtight effect. In this way, the transparent cover 34 not only can be stably arranged in the groove 22, but also has the efficacy of waterproof and simple manufacturing process. In some embodiments, a width w of the first shoulder 221 and the second shoulder 341 is 2 cm.

Referring to FIG. 11, in some embodiments, an outer side of the transparent cover 34 is a convex cambered surface and is provided with a semi-transparent film 343. In this way, it may be ensured that the light emitted by the first light-emitting element 321, the second light-emitting element 322, and the third light-emitting element 323 passes through the transparent cover 34 from the inside to the outside, and it is difficult to observe the display light module 32 inside from the outside of the transparent cover 34. In addition, the color of the semi-transparent film 343 is not limited. The semi-transparent film 343 mentioned herein may be in any color allowing light to transmit from the inside to the outside and preventing the internal display light module 32 from being easily seen from the outside. In some embodiments, the color of the semi-transparent film 343 is, for example but not limited to, silver or black.

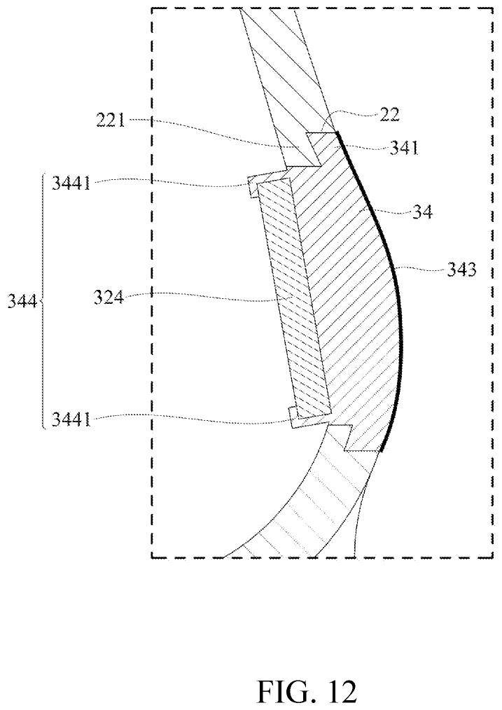

The display light module 32 may be fixed to the inside of the transparent cover 34 by using adhesive, by using a fixing mechanism, or by using screws and nuts. Referring to FIG. 12, in some embodiments, a fixed assembly 344 is arranged on an inner side of the transparent cover 34. The display light module 32 includes a board 324. The board 324 is arranged on the fixed assembly 344, and the first light-emitting element 321, the second light-emitting element 322, and the third light-emitting element 323 are arranged on the board 324. In some embodiments, the fixed assembly 344 has two corresponding hooks 3441, and two opposite edges of the board 324 are engaged by the two hooks 3441, so that the display light module 32 can be stably arranged on the inner side of the transparent cover 34, and the display light module 32 can be disassembled according to the requirements, which facilitates maintenance.

Refer to FIG. 2 and FIG. 12. In some embodiments, the controller 33 transmits a signal to the first light-emitting element 321, the second light-emitting element 322, and the third light-emitting element 323 by using a third signal transmission line 333. The third signal transmission line 333 may be fixedly connected to the board 324 or detachably connected to the board 324. The detachable connection means that, for example, but not limited to, an end of the signal line is provided with a connection terminal. The board 324 is provided with a connection jack, and is inserted into the connection jack through the connection terminal, so that the signal line can be detachably connected to the board 324, which facilitates maintenance.

What is claimed is:

1. A charging gun, applicable to a charger station, the charging gun comprising:
a charging gun body; and
a charge state display apparatus, comprising:
a charge state sensor, configured to sense a charge state of the charger station;
a display light module, arranged on the charging gun body and comprising a first light-emitting element, a second light-emitting element, and a third light-emitting element; and
a controller, electrically connected to the charge state sensor and the display light module and configured to control the first light-emitting element, the second light-emitting element, or the third light-emitting element to emit light according to the charge state.

2. The charging gun according to claim 1, wherein the charge state sensor comprises:
a terminal temperature sensor, arranged on the charging gun body and configured to sense a terminal temperature; and
an ambient temperature sensor, arranged on the charger station and configured to sense an ambient temperature, wherein
the controller is electrically connected to the terminal temperature sensor, the ambient temperature sensor, and the display light module, and is configured to individually control the first light-emitting element, the second light-emitting element, or the third light-emitting element to emit light according to the terminal temperature and the ambient temperature.

3. The charging gun according to claim 2, wherein the controller performs the following determinations according to a temperature difference, the terminal temperature, and the ambient temperature:
when the ambient temperature is greater than the terminal temperature minus the temperature difference, the controller generates a first control signal to the first light-emitting element, so that the first light-emitting element emits light;
when the ambient temperature is less than or equal to the terminal temperature minus the temperature difference, the controller generates a second control signal to the second light-emitting element, so that the second light-emitting element emits light; and
when the terminal temperature is greater than a critical temperature, the controller generates a third control signal to the third light-emitting element, so that the third light-emitting element emits light.

4. The charging gun according to claim 3, wherein the temperature difference is 5° C.

5. The charging gun according to claim 3, wherein the critical temperature is 85° C.

6. The charging gun according to claim 3, wherein the controller is further configured to determine whether the charger station is in a charging-in-progress state, so as to determine illumination modes of the first light-emitting element, the second light-emitting element, and the third light-emitting element.

7. The charging gun according to claim 6, wherein the illumination modes comprise a first illumination mode and a second illumination mode, and the first illumination mode is flickering and the second illumination mode is always illuminated.

8. The charging gun according to claim 7, wherein when the ambient temperature is greater than the terminal temperature minus the temperature difference and the charger station is charging, the controller generates the first control signal to the first light-emitting element, so that the first light-emitting element presents the first illumination mode; and when the ambient temperature is greater than the terminal temperature minus the temperature difference and the charger station is not charging, the controller generates the first control signal to the first light-emitting element, so that the first light-emitting element presents the second illumination mode.

9. The charging gun according to claim 7, wherein when the ambient temperature is less than or equal to the terminal temperature minus the temperature difference and the charger station is charging, the controller generates the second control signal to the second light-emitting element, so that the second light-emitting element presents the first illumination mode; and when the ambient temperature is less than or equal to the terminal temperature minus the temperature difference and the charger station is not charging, the controller generates the second control signal to the second light-emitting element, so that the second light-emitting element presents the second illumination mode.

10. The charging gun according to claim 7, wherein when the terminal temperature is greater than the critical temperature and the charger station is charging, the controller generates the third control signal to the third light-emitting element, so that the third light-emitting element presents the first illumination mode.

11. The charging gun according to claim 7, wherein the display light module is a display light strip or a display light block, and is arranged on a gun belly of the charging gun body.

12. The charging gun according to claim 1, wherein the controller performs the following determination according to the charge state:
when the charger station is in a standby state, the controller generates a fourth control signal to the first light-emitting element, so that the first light-emitting element emits light;
when the charger station is in a charging state, the controller generates a fifth control signal to the second light-emitting element, so that the second light-emitting element emits light; and
when the charger station is in a charging completed state, the controller generates a sixth control signal to the third light-emitting element, so that the third light-emitting element emits light.

13. The charging gun according to claim 12, wherein the charging gun body is provided with a groove, a transparent cover is arranged in the groove, and the display light module is arranged on an inner side of the transparent cover.

14. The charging gun according to claim 13, wherein a first shoulder is arranged along an open edge of the groove, a second shoulder is arranged along an edge of the transparent cover, the transparent cover is arranged in the groove, the second shoulder laps the first shoulder, and an adhesive layer is arranged between the second shoulder and the first shoulder.

15. The charging gun according to claim 14, wherein an outer side of the transparent cover is a cambered surface and is provided with a semi-transparent film.

16. The charging gun according to claim 15, wherein a fixed assembly is arranged on an inner side of the transparent cover, the display light module comprises a board, the board is arranged on the fixed assembly, and the first light-emitting element, the second light-emitting element, and the third light-emitting element are arranged on the board.

17. The charging gun according to claim 16, wherein the display light module is a display light block or a display light strip, and is arranged on a gun belly of the charging gun body.

18. The charging gun according to claim 17, wherein the first light-emitting element, the second light-emitting element, and the third light-emitting element are light-emitting diodes for three different colors.
